(19) United States
(12) Patent Application Publication
(10) Pub. No.: US 2014/0119737 A1
(43) Pub. Date: May 1, 2014

(54) System and Method for Detection of Speech Related Acoustic Signals by Using a Laser Microphone

(71) Applicant: VOCALZOOM SYSTEMS LTD., Modiin (IL)

(72) Inventor: Tal BAKISH, Modiin (IL)

(73) Assignee: VOCALZOOM SYSTEMS LTD., Modiin (IL)

(21) Appl. No.: 13/664,470

(22) Filed: Oct. 31, 2012

(51) Int. Cl. H04B 10/02

(52) U.S. Cl. 398/133

(57) ABSTRACT

A system for detection of speech related acoustic signals by using laser based detection that includes a mask configured for being worn over a face part of a speaker covering the speaker's mouth, where the mask includes at least one reflective coating covering at least one area of the mask that reflects collimated electromagnetic signals; and a laser microphone configured for detecting vibrations of the reflective coating area for detection of acoustic signals associated with speech of the speaker by using collimated electromagnetic signals. The mask the reflective coating area thereof allow enhancing detection of vibrations resulting from speech carried out by the speaker wearing said mask.

### FIELD OF THE INVENTION

The present invention generally relates to devices, apparatuses, systems and methods for detecting acoustic signals and more particularly to devices for optical detection of acoustic sounds.

### BACKGROUND OF THE INVENTION

Optical microphones allow optically detecting human speech related acoustic signals and often rely on facial vibrations for speech detection since optical signals have high sensitivity to vibrating surfaces. However, the output of the optical microphones is of much lower signal quality than that of commonly used acoustic microphones based on transducers that produce electric current upon being vibrated in response to speech related air vibrations.

U.S. Pat. No. 7,775,113 and U.S. application Ser. No. 11/841,134, which are incorporated herein by reference in their entirety, disclose an optical microphone system that includes an optical transmitter and receiver for receiving and transmitting optical signals (beams) for optical detection of speech related acoustic signals by detection of, inter alia, facial vibrations of a relevant speaker. These optical microphones can use techniques such as vibrometry, self-mix and/or interferometry, for instance, for acoustic signals detection.

### SUMMARY OF THE INVENTION

According to some embodiments of the present invention there is provided a system for detection of speech related acoustic signals by using laser based detection that includes a mask configured for being worn over a face part of a speaker covering the speaker's mouth, where the mask includes at least one reflective coating covering at least one area of the mask that reflects collimated electromagnetic signals; and a laser microphone configured for detecting vibrations of the reflective coating area for detection of acoustic signals associated with speech of the speaker by using collimated electromagnetic signals. The mask the reflective coating area thereof allow enhancing detection of vibrations resulting from speech carried out by the speaker wearing said mask.

Optionally, the reflective coating comprises at least one patch having a reflective surface, each patch is attached to the mask. Alternatively, the reflective coating comprises a coating layer covering at least one area of the mask. In other embodiments at least part of the mask is made from a reflective material.

According to some embodiments of the invention, the laser microphone uses vibrometry, self-mix and/or interferometry techniques to detect acoustic vibrations.

Optionally, the laser microphone comprises a laser based optical transmitter configured for transmitting a coherent laser beam towards the speaker's mouth area, which is covered by the mask, a corresponding optical sensor for detecting the reflected optical signals from the reflective coating thereof and a processor for processing the sensed signals for detecting the acoustic signals.

According to some embodiments, the laser microphone is connected to at least one processor for processing the sensed signals for detecting the acoustic signals from the laser microphone output, where the processor may be configured for operating at least one noise reduction algorithm.

According to some embodiments of the invention, the system further comprises one or more audio output devices such as speakers for outputting the acoustic output signal of the laser microphone.

### BRIEF DESCRIPTION OF THE DRAWINGS

FIG. 1 schematically illustrates a system for optical detection of speech related acoustic signals including a facial mask with multiple attached reflective patches, according to some embodiments of the present invention.

FIG. 2 schematically illustrates a system for optical detection of speech related acoustic signals including a facial mask coated by a reflective layer, according to other embodiments of the present invention.

FIG. 3 is a flowchart, schematically illustrating a process/method for detection of speech related acoustic signals by using laser based detection, according to some embodiments of the invention

### DETAILED DESCRIPTION OF SOME EMBODIMENTS OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention, in some embodiments thereof, provides a system for laser based detection of speech related acoustic signals, where the acoustic signals. According to some embodiments the system includes a mask configured for being worn over a face part of a speaker covering the speaker's mouth having one or more reflective surfaces thereover; and an optical microphone configured for optically detecting vibrations of the reflective surface or surfaces for detection of acoustic signals associated with speech of the speaker.

The one or more reflective surfaces may be attached to the mask (e.g. using reflective patches that are attached to areas over a regular face mask through adhesives) or coating the mask by having a reflective layer coating at least one area of the mask around configured to cover the mouth area of the speaker wearing thereof

The optical microphone may include a laser optical transmitter for transmitting a coherent laser beam towards the speaker's mouth area, which is covered by the special mask, and a corresponding optical receiver/sensor(s) for detecting the reflected optical signal thereof. Various aspects of the differences between the transmitted optical signal and the reflected received optical signal are used to detect and extract the speech related acoustic signal features. The optical microphone can be based on techniques for vibration detection such as vibrometry, self-mix and/or interferometry, for instance.

The mask may be designed as a surgeon mask, which is often made of lightweight materials and has straps for allowing a user to hold it worn over his/her face by tying the straps over his/her ears. The one or more reflective surfaces may be added to the mask by attaching (e.g. by adhering) one or more light-reflective patches over a standard surgeon mask, coating the mask with a coating layer adhered thereto, manufacturing the mask from a reflective material (e.g. a fabric having a reflective weave embedded thereto), or by using any other technique for creating reflective area(s) over a mask.

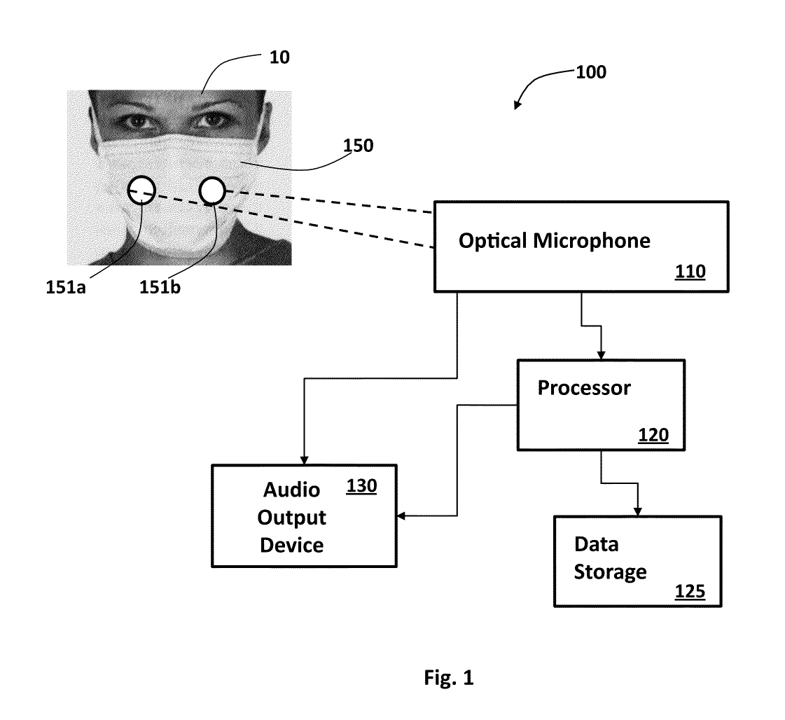

Reference is now made to FIG. 1, schematically illustrating a system 100 for optical detection of speech related acoustic signals, according to some embodiments of the invention. The system 100 includes: (i) an optical microphone 110; (ii) a mask 150 configured for being worn over a face part of a speaker 10 covering the speaker's mouth area; and (iii) one or more audio output devices such as a speaker 130.

According to some embodiments, as illustrated in FIG. 1, the system 100 also includes a computer processor 120 for receiving data/signals from the optical microphone 110 and analyzing/processing thereof capable of outputting data associated with the speech acoustic signal and data storage 125 for storing the processed data and/or the raw output of the optical microphone.

According to these embodiments, as shown in FIG. 1, the mask 150 includes a multiplicity of reflective surfaces 151a and 151b attached thereover in the moth area of the speaker 10. The reflective patches 151a and 151b may be, for example, adhered to a standard surgeon mask or printed thereover using fabric printing techniques.

According to some embodiments, the optical microphone 110 includes an infrared (IR) transmitter and receiver for transmitting IR signals and receiving the IR optical signals reflected back from the reflective as well as non-reflective surfaces of the mask 150 when the speaker 10 speaks for outputting a signal or data that represents the speech related acoustic signal outputted by the speaker 10.

Since the mask blocks some of the air exhaled by the speaker during speech, it enhances the vibrating related to speech and therefore enhances the ability to optically detect speech related vibrations. Adding reflective surfaces thereto further enhances the ability and quality of detection of the speech related vibration in the mouth area of the speaker.

For example, the optical microphone 110 includes means for carrying out interferometry between the transmitted and reflected optical (e.g. IR) signal such as an interferometer outputting an optical signal and/or data representing thereof indicative of the difference between the transmitted and reflected signals (such as phase shift therebetween). In other cases the optical microphone 110 uses self-mixing of the transmitted and reflected signals for outputting data/signal that is indicative of the speech related acoustic data/signal.

In other embodiments, coherent electromagnetic laser beams/waves in the non-visual frequency ranges may be used instead of optical signals, using reflective surfaces (e.g. painted, covered or coated) that can reflect collimated electromagnetic signals in these non-visual frequency ranges.

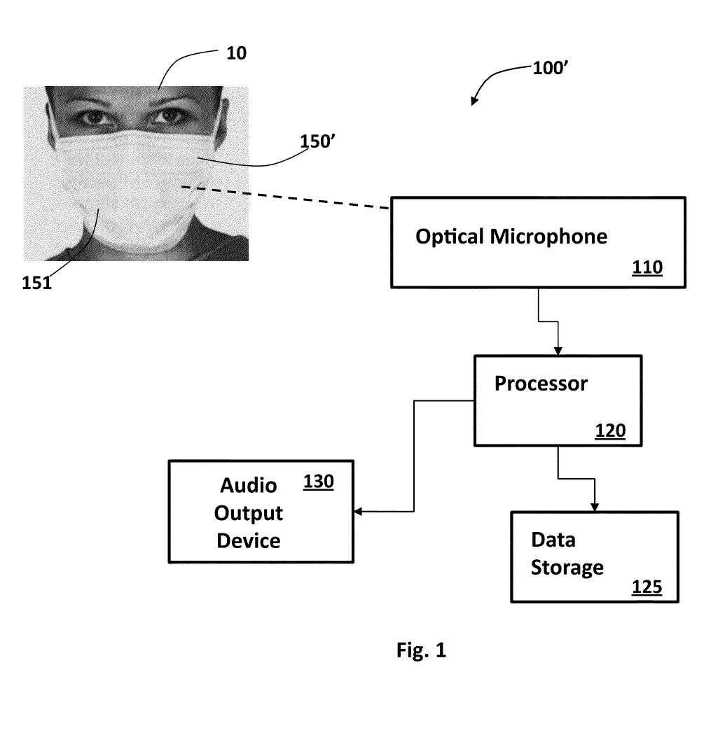

Reference is now made to FIG. 2, schematically illustrating another similar system 100′ for optical detection of speech related acoustic signals, according to some embodiments of the invention. The system 100′ includes: (i) the same optical laser microphone 110; (ii) another type of mask 150′ configured for being worn over a face part of a speaker 10 covering the speaker's mouth area; (iii) the audio output device 130; (iv) the computer processor; (v) and the data storage 125. This mask 150′ has a coating layer 151 thereover that is reflective in the signal range corresponding to the range of the laser microphone 110.

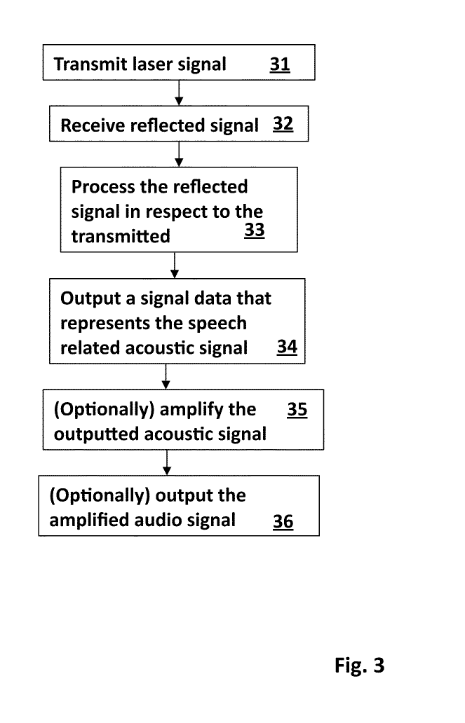

Reference is now made to FIG. 3, which is a flowchart; schematically illustrating a process/method for detection of speech related acoustic signals by using laser based detection, according to some embodiments of the invention. the method includes: (i) transmitting a collimated electromagnetic signal (e.g. optical IR signal) using a laser based microphone 31; (ii) receiving a reflected signal associated with the transmitted one, using the laser microphone, where the reflected signal is a signal that was reflected from a reflecting surface of a mask worn by the speaker 32; (iii) processing the reflected signal in respect to its corresponding transmitted signal 33 e.g. either by using optical means such as interferometry or self-mixing means and/or by analyzing the characteristics of the received reflected signal in respect to known characteristics of the transmitted signal (such as wavelength/frequency, intensity, phase and the like); and (iv) outputting the speech related extracted acoustic signal 34 either as data and/or as an acoustic signal.

The method may optionally include amplifying the extracted acoustic signal 35 and then outputting it by using audio output means such as a speaker and the like 36.

According to some embodiments of the invention, any one or more noise reduction, amplification and filtering techniques and algorithms may be used to output a high quality acoustic signal of the relevant speaker wearing the mask such as voice activity detection (VAD) techniques, comb filtering and the like.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

What is claimed is:

1. A system for detection of speech related acoustic signals by using laser based detection, said system comprising:
i) a mask configured for being worn over a face part of a speaker covering the speaker's mouth, said mask includes at least one reflective coating covering at least one area of said mask, said reflective coating is configured to reflect collimated electromagnetic signals; and
ii) a laser microphone configured for detecting vibrations of said reflective coating for detection of acoustic signals associated with speech of the speaker by using collimated electromagnetic signals, outputting an output signal that is indicative of the acoustic signal of the speaker,
wherein said mask and at least one reflective coating thereof allow enhancing detection of vibrations resulting from speech carried out by the speaker wearing said mask.

2. The system according to claim 1, wherein said reflective coating comprises at least one patch having a reflective surface, each said patch is attached to said mask.

3. The system according to claim 1, wherein said reflective coating comprises a coating layer covering at least one area of said mask.

4. The system according to claim 1, wherein at least part of said mask is made from a reflective material.

5. The system according to claim 1, wherein said laser microphone uses vibrometry, self-mix and/or interferometry techniques to detect acoustic vibrations.

6. The system according to claim 1, wherein said laser microphone comprises a laser based optical transmitter configured for transmitting a coherent laser beam towards the speaker's mouth area, which is covered by said mask, a corresponding optical sensor for detecting the reflected optical signals from said reflective coating thereof and a processor for processing the sensed signals for detecting the acoustic signals.

7. The system according to claim 1, wherein said laser microphone is connected to at least one processor for processing the sensed signals for detecting the acoustic signals from the laser microphone output.

8. The system according to claim 7, wherein said processor is configured for operating at least one noise reduction algorithm.

9. The system according to claim 1 further comprising at least one audio output device for outputting the output signal of the laser microphone.
